(19) United States
(12) Patent Application Publication
(10) Pub. No.: US 2015/0112650 A1
(43) Pub. Date: Apr. 23, 2015

(54) RADIO CHANNEL PREDICTION BASED ON STREET MAPS USING MODULAR ENVIRONMENTAL ELEMENTS

(71) Applicant: Alcatel-Lucent USA Inc., Murray Hill, NJ (US)

(72) Inventors: Dmitry CHIZHIK, Highland Park, NJ (US); Jonathan LING, North Brunswick, NJ (US); Reinaldo VALENZUELA, Holmdel, NJ (US)

(21) Appl. No.: 14/060,811

(22) Filed: Oct. 23, 2013

(51) Int. Cl. G06F 17/50; H04W 16/18

(52) U.S. Cl. CPC G06F 17/5009; H04W 16/18
USPC 703/2

(57) ABSTRACT

A method of modeling predicted values, at a selected point, of radio fields originating from a source in a geographic area including a plurality of streets and a plurality of buildings includes determining a first path from the source to the selected point, the first path including a first segment, and predicting a value, at the selected point, of a radio field originating from the source by modeling the first segment as a first waveguide, and at least one of (1) generating a first radio field coupling equation by coupling the first waveguide with a second waveguide, the second waveguide being a model of a second segment, the second segment being included in the first path, and (2) generating a second radio field coupling equation by coupling the first waveguide with an indoor model for modeling radio fields traveling through a building or outer wall.

### BACKGROUND OF THE INVENTION

1. Field

The present invention relates generally to radio channel prediction and/or modeling.

2. Related Art

For the purpose of planning wireless communications networks that provide coverage for mobile devices in urban or suburban areas, including, for example, macro cells, pico cells or metro cells, accurate prediction and modeling of radio fields for outdoor and indoor locations is important for determining desirable locations of access points or for evaluating the performance of existing access points. Related art methods for modeling radio fields include slope-intercept based models and ray tracing.

The Hata model, which is one example of the slope-intercept based models, relies on functions defining path-loss as a function of distance. Empirical extensions to the Hata model are often used that consider adjustments to path loss due to environmental elements such as building, bodies of water, and trees. With ray tracing, environmental elements such as building may be described as a series of walls or surfaces. Modeling using ray tracing, for example in an area including buildings, may include predicting interactions between rays emanating from a source and the surfaces associated with the buildings.

### SUMMARY OF THE INVENTION

One or more embodiments relate to a method of using locations of streets and buildings, for example locations provided by a street map, to model radio fields associated with access points and/or mobile devices.

According to at least one example embodiment, a method of modeling predicted values of radio fields originating from a source in a geographic area including a plurality of streets and a plurality of buildings includes selecting a point within the geographic area; determining a first path from the source to the selected point, the first path including a first segment corresponding to a first street from among the plurality of streets, the first segment running along the first street; and predicting a value, at the selected point, of a radio field originating from the source. Further, according to at least one example embodiment, predicting the value of the radio field at the selected point also includes modeling the first segment as a first waveguide. Further, according to at least one example embodiment, predicting the value of the radio field at the selected point also includes at least one of (1) generating a first radio field coupling equation by coupling the first waveguide with a second waveguide, the second waveguide being a model of a second segment, the second segment being included in the first path and running along a second street from among the plurality of streets, and (2) generating a second radio field coupling equation by coupling the first waveguide with an indoor model for modeling radios fields traveling through the building and outer wall. Further, according to at least one example embodiment, predicting the value of the radio field at the selected point also includes predicting the value of the radio field at the selected point based on at least one of the first and second radio field coupling equations.

The indoor model may be a diffusion model.

The modeling of the first segment as a first waveguide may include generating the first waveguide such that the first waveguide has a width corresponding to a width of the first street.

The first and second streets may intersect at a corner, the first and second segments may meet at the corner, and the predicting the value of the radio field at the selected point may include the generation of the first coupling equation.

The generation of the first coupling equation may include generating the first coupling equation based on a corner angle, where the corner angle may an angle of the corner at which the first and second segments meet.

The generation of the first coupling equation may include modeling the corner as a waveguide junction between the first and second waveguides.

7. The predicting the value of the radio field at the selected point may include the generating a second coupling equation if the selected point is located inside a first building from among the plurality of buildings.

The generating a second coupling equation may include generating the second coupling equation based on a diffusion model, the diffusion constant corresponding to the first building.

The method may further include determining a second path from the source to the selected point. Predicting the value of the radio field at the selected point may include determining a first radio field contribution based on the at least one of the first and second coupling equations, determining a second radio field contribution based on the second path, generating a summation value by performing a summation operation based on the first and second radio field contributions, and predicting the value of the radio field at the selected point based on the summation value.

10. According to at least one example embodiment, a radio field modeling device includes a processor programmed to execute operations for modeling predicted values of radio fields originating from a source in a geographic area including a plurality of streets and a plurality of buildings. According to at least one example embodiment, the operations include selecting a point within the geographic area; determining a first path from the source to the selected point, the first path including a first segment corresponding to a first street from among the plurality of streets, the first segment running along the first street; and predicting a value, at the selected point, of a radio field originating from the source. Further, according to at least one example embodiment, predicting the value of the radio field at the selected point includes modeling the first segment as a first waveguide. Further, according to at least one example embodiment, predicting the value of the radio field at the selected point also includes at least one of (1) generating a first radio field coupling equation by coupling the first waveguide with a second waveguide, the second waveguide being a model of a second segment, the second segment being included in the first path and running along a second street from among the plurality of streets, and (2) generating a second radio field coupling equation by coupling the first waveguide with an indoor model for modeling radios fields traveling through the building and outer wall. Further, according to at least one example embodiment, predicting the value of the radio field at the selected point also includes predicting the value of the radio field at the selected point based on at least one of the first and second radio field coupling equations.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1A illustrates a portion of a wireless communication network.

FIG. 1B is a diagram illustrating an example structure of radio field modeling device 101.

FIG. 2 is a flow chart illustrating an example method of modeling radio field characteristics using street information according to one or more example embodiments.

FIG. 3 illustrates an example of street layout and AP position information for an urban geographical region 300 according to at least one example embodiment.

FIG. 4 is a flow chart illustrating an example of step S230 in FIG. 2 in greater detail, according to at least one example embodiment.

### DETAILED DESCRIPTION OF EXAMPLE EMBODIMENTS

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term mobile may be considered synonymous to, and may hereafter be occasionally referred to, as a access terminal, terminal, user equipment (UE), mobile unit, mobile station, mobile user, subscriber, user, remote station, receiver, etc., and may describe a remote user of wireless resources in a wireless communication network. The term access point (AP) may be considered synonymous to and/or referred to as a base station (BS), base transceiver station (BTS), NodeB, evolved Node B, femto cell, etc. and may describe equipment that provides the radio baseband functions for data and/or voice connectivity between a network and one or more users.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types. The program modules and functional processes discussed herein may be implemented using existing hardware including one or more digital signal processors (DSPs), application-specific-integrated-circuits, field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

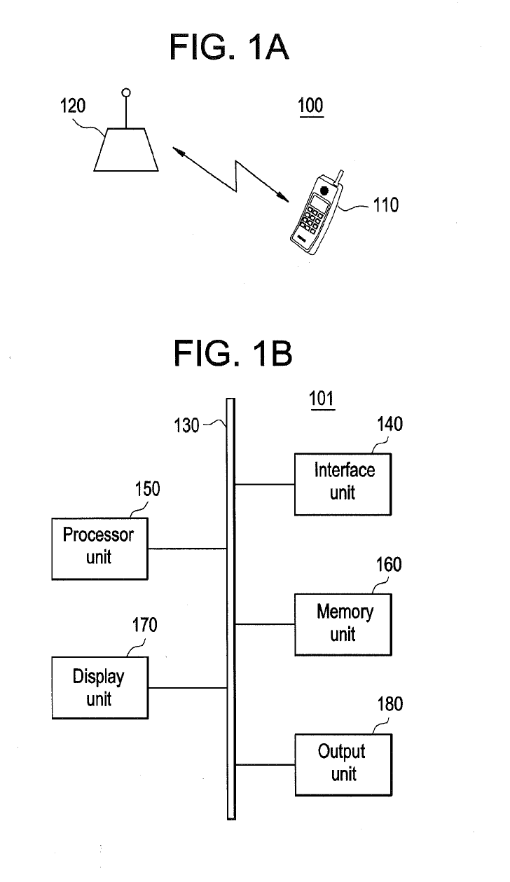

FIG. 1A illustrates a portion of a wireless communication network 100. Wireless protocols the wireless communications network 100 may support include, for example, the universal mobile telecommunications system (UMTS), wideband code division multiple access (W-CDMA), and long term evolution (LTE) protocols. The wireless communication network 100 may provide wireless coverage for a mobile 110 via an access pint (AP) 120. The AP 120 may provide the mobile 100 with bi-directional wireless access to a core network (not shown) of the wireless communications network 100 when the mobile 100 is within a cell, pico cell, femto cell, metro cell and/or geographical region associated with the BS 120. Accordingly, the BS 120 and the mobile 110 are both capable of transmitting and receiving data to and from one another wirelessly using radio signals.

However, if the AP 120 and mobile 110 are located in an urban environment, the layout of environmental features such as streets and buildings relative to the locations of the AP 120 and the mobile 110 will have significant effect on the strength of the radio signals received at the mobile device from the AP 120. Accordingly, for network planning and/or network performance evaluation purposes, it is important to be able to predict the characteristics (e.g., strength, direction, and/or spatial correlation) of the radio fields associated with the radio signals generated by the AP 120 at various points within the urban area where the mobile 110 could be located.

Simple distance based, slope-intercept models, like for example the Hata model, can be used to model predictions of radio field characteristics of an Access Point within an urban area. However, the simple distance based models may not be capable of predicating directivity of radio fields. Further, the simple distance based models may ignore streets. Accordingly, the ability of simple distance based models, like the Hata model, to predict propagation of radio signals along streets may be poor, particularly when an AP is located below building height. Further, with respect to predicting radio field characteristics inside buildings, the simple distance based models may be augmented with empirical data such as a fixed penetration loss associated with buildings. However, the fixed penetration loss may not be accurate for the dependence of building penetration on range (e.g., distance from the AP).

Ray tracing can also be used to model predictions of radio field characteristics of an Access Point within an urban area including directivity of radio fields. However, the computational costs of ray tracing are great. Further, in order to achieve accurate results with respect to the penetration of radio signals into buildings, it may be necessary to obtain detailed structural descriptions of each of the buildings in the urban area being modeled. It may not be practical, economical or even possible, to obtain such detailed information for an urban area including several buildings.

Accordingly, it would be desirable to develop a method of modeling radio field characteristics associated with an AP which provides accurate predictions of radio fields inside buildings without requiring detailed schematic information of any of the buildings included in the area being modeled. A method of modeling radio field characteristics using street information according to one or more example embodiments will now be discussed in greater detail below.

According to an embodiment of the method of modeling radio field characteristics, street information, including, for example, street maps, may be used to generate accurate models of radio fields within urban areas or other areas including several buildings separated by streets or paths. The method of modeling radio field characteristics according to at least one example embodiment models radio fields along streets using electromagnetic waveguide formulas. Further, radio fields inside buildings are modeled by using diffuse medium formulas. Thus, according to at least one example embodiment, streets within an area being modeled are treated as waveguides and interior spaces of buildings within the area are treated as diffuse mediums. Accordingly, information as simple as a street map may be used to model radio field characteristics within a geographical area having several buildings including, for example, urban areas. An example structure of network planning device implementing the method of modeling radio field characteristics according to at least one example embodiment will now be discussed in greater detail below with reference to FIG. 1B.

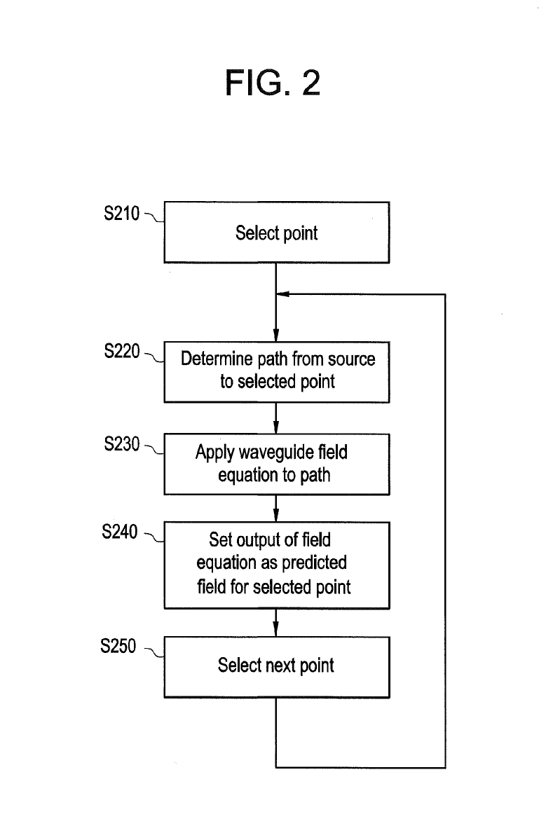

FIG. 1B is a diagram illustrating an example structure of radio field modeling device 101. Referring to FIG. 1B, the radio field modeling device 101 may include, for example, a data bus 130, an interface unit 140, a processor 150, a memory unit 160, a display 170, and an output unit 180. The interface unit 140, processor unit 150, memory unit 160, display unit 170, and an output unit 180 may send and receive data to and from one another using the data bus 130. The interface unit 140 is a device that includes hardware, with or without software, for receiving data including, for example, radio field characteristic information and street layout (e.g., street map) information, via one or more wired and/or wireless connections to one or more external data sources. The processor 150 may be, for example, a microprocessor capable of executing instructions included in computer readable code. The processor 150 may also generate signals to control the operations of other units including, for example one or more of the data bus 130, interface unit 140, a memory unit 160, display 170, and output unit 180. The memory unit 160 may be any device capable of storing data including magnetic storage, flash storage, or the like. The display 170 may be any device capable of displaying data including, for example, a computer monitor, a PDA display, or the like. The output unit 180 may be any device capable of outputting data. An example method for operating the radio field modeling device 101 will now be discussed in greater detail below with reference to FIG. 2.

FIG. 2 is a flow chart illustrating an example method of modeling radio field characteristics using street information according to one or more example embodiments.

According to at least one example embodiment, the radio field modeling device 101 may be supplied with information describing an AP, which may be an actual AP (e.g., for network performance analysis purposes) or potential AP (e.g., for network planning purposes), and information describing a layout of streets and buildings surrounding the AP.

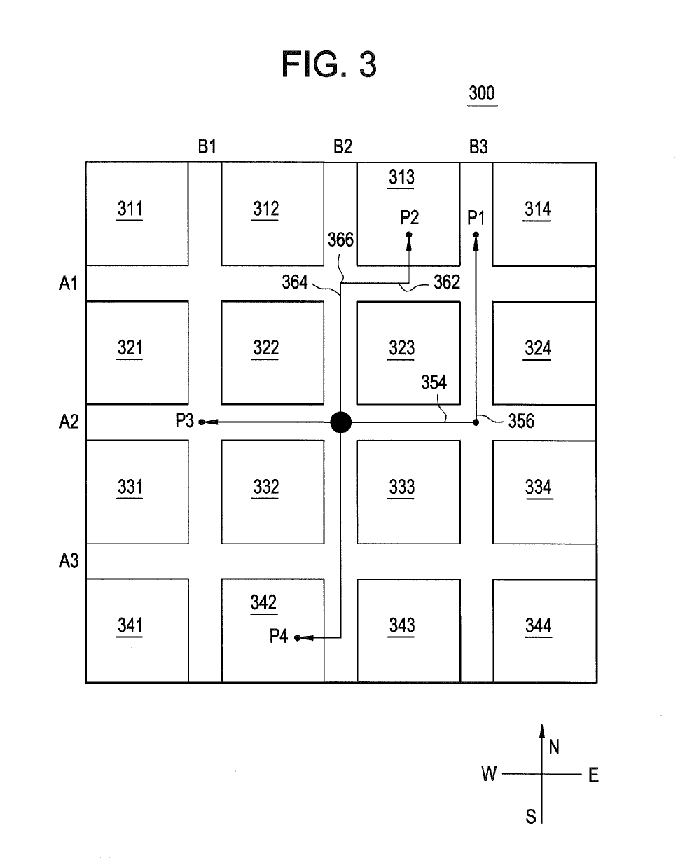

FIG. 3 illustrates an example of street layout and AP position information for an urban geographical region 300 according to at least one example embodiment. As illustrated in FIG. 3, the street layout information may take the form of a street map. In the example illustrated in FIG. 3, buildings 311-344 are separated by vertical streets B1-B3 and horizontal streets A1-A3. A position of an AP whose radio fields are being modeled is represented in FIG. 3 as source S.

Herein, the AP which is the origin of the radio fields being modeled in accordance with one or more example embodiments may be considered synonymous to and/or referred to as the source S.

According to at least one example embodiment, radio field characteristic information is calculated for each of several points within a geographical area surrounding the source S. For example, for each one of several points within the geographical region 300, the radio field modeling device 101 predicts the radio field characteristics which would be experienced by a mobile that is located at that point and is receiving radio signals from the Source S.

For example, according to at least one example embodiment, propagation of a radio field down a street is treated as a waveguide, with the source S exciting waveguide modes that propagate down the street to be picked up by a receiver. As will be discussed in greater detail below, for around-the-corner propagation down paths having multiple segments connected at one or more corners, the corners are treated as waveguide junctions, and thus, each straight segment treated as a waveguide with its own modal field, coupled at a junction using formulas appropriate for mode-mode coupling. Propagation between outdoor source S and a node located inside a building is treated as coupling between a waveguide (representing the street) and a diffuse medium (representing the indoor environment). Such coupling may be computed, for example, using Huygens principle.

Returning to FIG. 2, in step S210, a point is selected. For example, the radio field modeling device 101 may selects a point within the geographical region 300 for which to predict radio field characteristics using the street layout and AP position information illustrated in FIG. 3. As used herein, the term “the selected point” refers to the point selected in step S210.

For the purpose of simplicity, the example process for predicting radio field characteristics illustrated in FIG. 2 is shown such that each cycle of the steps illustrated in FIG. 2 results in the prediction of radio field characteristics with respect to one point within the geographical region 300. However, according to at least one example embodiment, the method illustrated in FIG. 2 may be used to predict radio field characteristics for several or all points being modeled within the geographical region 300 sequentially and/or in parallel. For example, the radio field modeling device 101 may run several iterations of the method illustrated in FIG. 2 in parallel in order to predict field characteristics for several points.

In step S220, a path is determined from the source to the selected point. For example, the radio field modeling device 101 may use the street layout information to determine a shortest path from the source S to the selected point. As an example, FIG. 3 illustrates first through fourth points P1-P4. First point P1 is located north of the source S on vertical road B3; second point P2 is located north of the source S in building 313; third point P3 is located west of the source S on horizontal road A2; and fourth point P4 is located south of the source S in building 342. The paths between the source S and each of the first through fourth points P1-P4 are illustrated with arrows beginning at the source S and ending at the respective points P1-P4. Accordingly, the paths corresponding to points P1-P4 and illustrated in FIG. 3 represent examples of paths which may be determined by the radio field modeling device 101 in step S220.

According to at least one example embodiment, for a given point located on a street, the path from the source S to the given point determined in step S220 may be the shortest route from the source S to the given point, where the route is located only on the streets.

According to at least one example embodiment, for a given point located in a building, the path from the source S to the given point determined in step S220 may have two parts. The first part is, for example, the shortest route from the source S to an entry point, the entry point being defined as a point that is (a) located on a street; and (b) closest to the given point out of all other points located on streets. The second part is, for example, a straight line between the entry point and the given point. Once the path from the source S to the selected point is determined in step S220, the method may proceed to step S230.

In step S230, a waveguide field expression is applied to the path determined in step S220. For example, the radio field modeling device 101 may determine an output of a field function U(x, y, z) corresponding to the path determined in step S220.

As is discussed above, according to at least one example embodiment, streets are treated as waveguides. Accordingly, as used herein, the value ‘a’ represents a width of the waveguide (e.g., the width of the street), ‘x’ represents an axis parallel to the width ‘a’ (e.g., an ‘x’ coordinate represents a position along a width of the street), ‘z’ represents an axis perpendicular to ‘a’ (e.g., a ‘z’ coordinate represents a position along a length of the street), and ‘y’ represents a vertical axis that is perpendicular to the ‘x’ and ‘z’ axes (e.g., a ‘y’ coordinate represents a vertical position relative to the surface of the street).

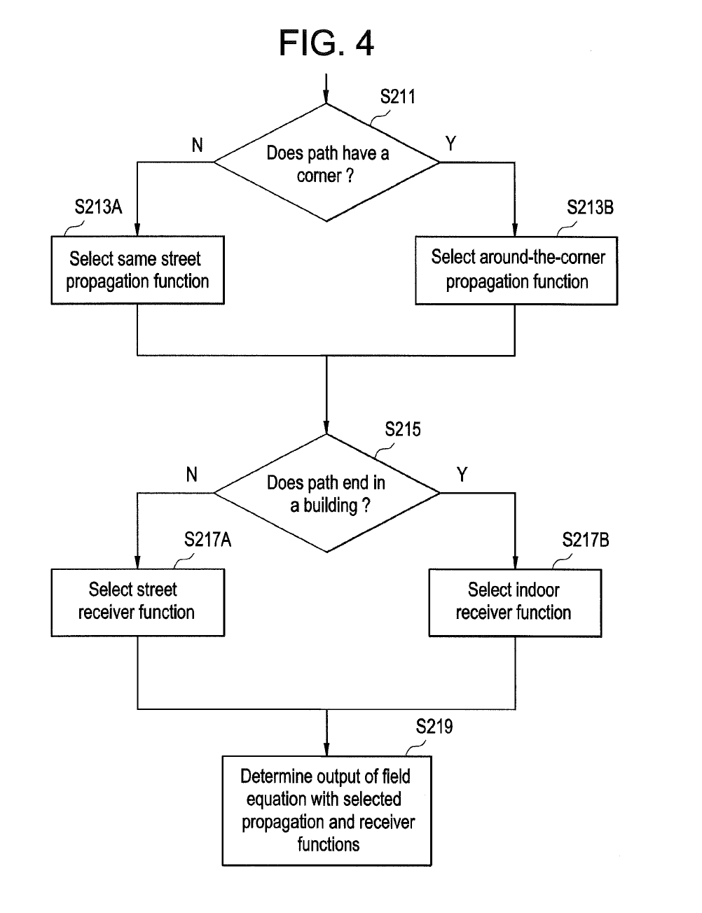

In a radio field model generated in accordance with at least one example embodiment, the source S excites fields in a waveguide, resulting fields propagate down straight waveguide segments, coupling at turns into a next straight waveguide segment, etc. until the fields reach the destinations, where they are received. Consequently, as will be discussed in greater detail below with reference to FIG. 4, the field function U(x, y, z) has three components: a source function, a propagation function, and a receiver function. Further, the formulas used for the propagation and receiver functions may vary based on characteristics of the point selected in step S210. Step S230 will now be discussed in greater detail with reference to FIG. 4 below.

FIG. 4 is a flow chart illustrating an example of step S230 in FIG. 2 in greater detail, according to at least one example embodiment. Referring to FIG. 4, in step S211 the method includes determining whether or not the path associated with the point selected in step S210 includes a corner. For example, according to at least one example embodiment, the radio field modeling device 101 determines that a corner exists in a path when a path traveling down one street changes to a second street at an intersection of the first and second streets. Referring to FIG. 3 as an example, the paths corresponding to both first and second points P1 and P2 both have corners, while the paths corresponding to both third and fourth points P3 and P4 do not have corners. The corner 356 in the path corresponding to the first point P1 is located at the intersection of vertical road B3 and horizontal road A2, and the corner 366 in the path corresponding to the second point P2 is located at the intersection of vertical road B2 and horizontal road A1.

In step S211, if there are no corners in the path associated with the selected point, the method proceeds to step S213A. For example, if the radio field modeling device 101 determines in step S211 that there are no corners in the path, in step S213A, the radio field modeling device 101 may employ the same-street propagation function as the propagation function for the field function U(x, y, z). According to at least on example embodiment, with propagation down a straight waveguide (e.g., a path with no corners), each modal coefficient is “progressed” down the waveguide by multiplying it by the appropriate modal loss factor and shifting its phase, as is standard in waveguide propagation modeling. Expression (1) illustrates an example of the same-street propagation function Pₘ(y,z).

$${P}_{m} ( y , z ) = \frac{1}{4 π {β}_{m}} \sqrt{\frac{2 π {β}_{m}}{iz}} {e}^{{iβ}_{m} z} {e}^{{{iβ}_{m} ( {y}_{s} - y )}^{2} / 2 z} {L}_{m} ( z ) \qquad ( 1 )$$

Referring to expression (1), ‘y’ and ‘z’ are waveguide coordinates of the selected point, and are defined above with reference to step S230. For example, if the third point P3 is the selected point, y would be a vertical distance along the y axis between a surface of the street and a location of the third point P3, and z would be a lateral distance along the z axis between the source S and the third point P3. The value ‘i’ is the imaginary unit, the value βₘ used in expression (1) is defined below, ‘yₛ’ represents a position along the ‘y’ axis at which the source S is located, Lm (z) represents the range dependent modal loss, that may be derived for a generic lossy waveguide, in accordance with known methods. The value ‘m’ identifies an (integer) index of a mode. As is known, a waveguide may have many modes. The term βₘ used in the same-street propagation function Pₘ(y,z) is defined below in expression (2).

βₘ=\sqrt{k²−(mπ/a)²}, (2)

where, ‘a’ is the width of the waveguide associated with the path corresponding to the selected point as is described above with reference to step S230 k is the wavenumber related to wavelength λ by k=2π/λ.

Returning to step S211, if it is determined that there is a corner in the path, the method proceeds to step S213A. For example, if, in step S211, the radio field modeling device 101 determines there is a corner in the path, in step S213A, the radio field modeling device 101 may employ the around-the-corner propagation function as the propagation function for the field function U(x, y, z). According to at least one example embodiment, modes coupling at street corners are treated as waveguide junctions, and thus, each of the incident modes excites a mode in a subsequent path segment to an extent described by a coupling coefficient C. The coupling coefficient C may be computed by integrating along a boundary a product of the waveguide mode fields in the incident and subsequent waveguide segments. Such coefficients may be pre-computed (e.g., computed before executing the steps illustrated in FIG. 2) and stored in a coupling matrix for later retrieval. Expression (3) illustrates an example of the around-the-corner propagation function Pₘₙ(z₁,z₂,y).

The transmitter and receiver may be placed around a corner with respect to one another, at distances z₁ and z₂ from the corner, respectively. Now excited modes are coupled at the street intersection onto a new set of modes appropriate for the intersecting street in expression (3), two intersecting streets are treated as two waveguides that meet, thereby forming a corner, for example, a 90° corner.

$${P}_{mn} ( {z}_{1} , {z}_{2} , y ) = [ {P}_{m} ( {z}_{2} ) \sqrt{{z}_{2}} {e}^{{iβ}_{m} {z}_{2}} ] {C}_{mn} [ {P}_{n} ( {z}_{1} ) \sqrt{{z}_{1}} {e}^{{iβ}_{n} {z}_{1}} ] {e}^{i {k ( {y}_{s} - y )}^{2} / ( {z}_{1} + {z}_{2} )} \sqrt{\frac{2 π}{k ( {z}_{1} + {z}_{2} )}}$$

(3)

As is shown by the path associated with the first point P1 illustrated in FIG. 3, a path with a corner may be interpreted as a path with two path segments. For example, the path associated with the first point P1 has a first path segment 354 that starts at the source S and extends east along the second horizontal street A2 to the corner 356 at the third vertical street B3; and a second path segment 352 that starts at the corner 356 and extends north along the third vertical street B3 to the first point P1. Similarly, the path associated with the second point P2 has a first path segment 364 connected to a second path segment 362 by a corner 366.

Referring to expression (3), the value ‘n’ represents an integer index of a mode for a first path segment which, according to at least one example embodiment, may be the path segment that includes the source S. The value ‘m’ represents an integer index of a mode for a second path segment. The values z₁ and z₂ represent coordinates for the first and second path segments respectively. For example, if the first point P1 is the selected point, the value z₁ is the distance between the source S and the corner 356, and the value z₂ is the distance between the corner 356 and the first point P1.

As used herein, the x, y and z axes are relative to the waveguide (e.g., street) with which they are being used. For example, though they are perpendicular to one another, both the values z1 and z2 represent distances along the z axes of their respective path segments.

Referring again to expression 3, y is a position along the y axis of the selected point, and yₛ represents a position along the y axis at which the source S is located. According to at least one example embodiment, the value βₘ used in expression (3) is defined above in expression (2). Further, the value βₙ may be defined as follows.

βn=\sqrt{k²−(nπ/a)²} (4)

Additionally, in expression (3), the values i and k may have the same definitions as those described above with reference to expression (1) and (2), and the functions Pₘ(z₂) and Pₙ(z₁) may be defined, respectively, by expressions (5) and (6) below, where Lₘ(z₂) and Lₙ(z₁) represent the ranges dependent modal loss for modes m and modes n, respectively.

$$\begin{matrix}{P}_{m} ( y , {z}_{2} ) = \frac{1}{4 π {β}_{m}} \sqrt{\frac{2 π {β}_{m}}{{iz}_{2}}} {e}^{i {kz}_{2}} {L}_{m} ( {z}_{2} ) & ( 5 ) \\ {P}_{n} ( y , {z}_{1} ) = \frac{1}{4 π {β}_{n}} \sqrt{\frac{2 π {β}_{n}}{iz}} {e}^{i {kz}_{1}} {L}_{n} ( {z}_{1} ) & ( 6 )\end{matrix}$$

The values Lₘ(z₂) and Lₙ(z₁) may be derived for a generic lossy waveguide, in accordance with known methods. Further, the value Cₘₙ in expression 3 is a coupling matrix which may be defined by the following expression:

$${C}_{mn} = - \frac{1}{4} {\sum }_{{s}_{1} , {s}_{2} ∈ [ - 1 , 1 ]} {e}^{- i {α}_{m , n , {s}_{1} , {s}_{2}}} \frac{sin {α}_{m , n , {s}_{1} , {s}_{2}}}{{α}_{m , n , {s}_{1} , {s}_{2}}} {s}_{1} {s}_{2} i [ \frac{n π {s}_{2}}{a} sin θ / 2 + \frac{m π {s}_{1}}{a} sin θ / 2 + ( {β}_{m} - {β}_{n} ) cos θ / 2 ] \\ {α}_{m , n , {s}_{1} , {s}_{2}} = ( {ms}_{1} - {ns}_{2} ) \frac{π}{2} cos θ / 2 + ( {β}_{m} - {β}_{n} ) \frac{a}{2} sin θ / 2 \qquad ( 7 )$$

Referring to expression (7), the values s1 and s2 are summation indices each of which are members of the set [−1,1], the value θ is an angle of the corner between the first and second path segments, and, as is discussed above with reference to step S230, the value ‘a’ represents the street width of the first and second path segments. For example, if the first point P1 illustrated in FIG. 3 is the selected point, the angle θ would be the angle of the corner 356. The remaining elements of expression (7) may have the same definitions as those provided with reference to expressions (2)-(6).

Once one of the same-street or around-the-corner propagation functions is selected in either step S213A or step S213B, the method may proceed to step S215. In step S215, the method includes determining whether or not the path associated with the point selected in step S210 ends in a building. For example, the radio field modeling device 101 may determine, based on information describing a layout of streets and buildings surrounding the source S, whether or not the point selected in step S210 is within a street or a building.

If, in step S215, it is determined the selected point is located in a street, the method proceeds to step S217A. For example, in step S217A, the radio field modeling device 101 may select the street receiver function as the receiver function for the field equation U(x, y, x). When the selected point is in the street, reception maybe treated in, for example, the standard manner of a point receiver in a waveguide, and thus, each modal coefficient may be the mode function evaluated at the receiver location. For example, the street receiver function may be defined as:

$${R}_{m} ( x ) = \sqrt{\frac{2}{a}} sin ( m π x / a ) , \qquad ( 8 )$$

For each path associated with a selected point, there will be a last segment. For selected points located in a street, the last segment is a segment closest to the selected point. Using the first point P1 as an example of the point selected in step S210, the last segment is the second segment 352, not the first segment 354. Using the third point P3 as an example of the point selected in step S210, there are no corners in the path corresponding to the third point P3, so there is only one path segment, and that path segment is the last segment.

In equation 8, the value m is an integer index of a mode associated with the last segment, the value ‘a’ is a width of the last segment, and x is a waveguide coordinate of the selected point along the x axis as is discussed above with respect to step S230.

If, in step S215, it is determined that the selected point is located in a building, the method proceeds to step S217B. For example, in step S217B, the radio field modeling device 101 may select the building receiver function as the receiver function for the field equation U(x, y, x).

When the selected position is indoors, the reception of each mode may be computed by propagating the indoor field to an exterior wall (for example using diffusion or some other known indoor model) and coupling onto a waveguide field. According to at least one example embodiment, the coupling may be accomplished by computing the complex coefficient with which a waveguide mode is excited. This complex coefficient may be determined by integrating a product of the field on one side of a boundary and the modal field on the other side of the boundary. The building receiver function may be defined as:

$${R}_{m} ( y ) = \frac{m π}{a} {\sqrt{\frac{2}{a}} [ \frac{π {dT}^{2}}{2 κ {k}^{2}} {e}^{- κ d} ( κ / d + 1 / {d}^{2} ) ]}^{1 / 2} {e}_{m} ( y ) \qquad ( 9 )$$

As is discussed above with reference to expression 8, for each path associated with a selected point, there will be a last segment. For selected points located in buildings, according to at least one example embodiment, the last segment is a closest path segment on a street which touches, or alternatively, is closest to, the building in which the selected point is located. Using the second point P2 illustrated in FIG. 3 as an example of the selected point, the second segment 362 would be the last segment, and the first segment 364 would not. Using the fourth point P4 as an example of the selected point, there are no corners, so there is only one path segment, and that path segment would be the last segment. According to at least one example embodiment, the z coordinate of the last segment is defined as the z coordinate closest to the selected point, and the y coordinate of the last segment is defined as the y coordinate closest to the selected point.

Returning to expression (9), y is the y coordinate of the last segment corresponding to the selected point, and d is a depth of the selected point measured from the selected point to a position on an exterior wall of the building in which the selected point is located. The exterior wall used for measuring d may be, for example, an exterior wall closest to the last segment associated with the selected point. The position on the exterior wall used for measuring d may be, for example, a position closest to the distance z of the last segment associated with the selected point. Further, according to at least one example embodiment, the value m used in equation (9) is an integer index of a mode associated with the last segment, the value ‘a’ is a width of the last segment, the value T is a field transmission coefficient for the building exterior wall, the value k is a wavenumber defined as k=2π/λ, the value K is an indoor diffusion constant, and the function eₘ (y) is a complex Gaussian distributed random variable of zero mean and unit variance. The field transmission coefficient T accounts for exterior wall penetration and may be computed using known methods including, for example, methods for computing a plane wave incident normally on a concrete wall. An example of the indoor diffusion constant κ is discussed, for example, in “Radio Wave Diffusion Indoors and Throughput Scaling with Cell Density”, IEEE Trans. on Wireless Communications, September, 2012 by D. Chizhik, J. Ling, R. A. Valenzuela, the entire contents of which are incorporated herein by reference.

Once one of the street or building reception functions is selected in either step S217A or step S217B, the method may proceed to step S219. For example, in step S219, the radio field modeling device 101 may determine an output of the field equation U(x,y,z) based on the propagation and receiver functions selected in steps S211-S217B.

For example, if the same-street propagation function is selected in step S213A, the field equation U(x,y,z) may be defined as follows:

$$U ( x , y , z ) = λ \sqrt{{P}_{T}} {\sum }_{m} {R}_{m} ( x , y ) {P}_{m} ( y , z ) {S}_{m} ( {x}_{s} ) , \qquad ( 10 )$$

and if the around-the-corner propagation function is selected in step S213B, the field equation U(x,y,z) may be defined as follows:

$$U ( x , y , z ) = λ \sqrt{{P}_{T}} {\sum }_{m , n} {R}_{m} ( x , y ) {P}_{mn} ( {z}_{1} , {z}_{2} , y ) {S}_{n} ( {x}_{s} ) . \qquad ( 11 )$$

For both expressions 10 and 11, λ is the wavelength and PT is the transmit power, and the expression used as the receiver function R is expression (8) if the street receiver function is chosen in step S217A, and expression (9) if the building receiver function is chosen in step S217B. Further, according to at least one example embodiment, the function Pₘ(y,z) used in expression 10 may be the function defined above by expression (1), and the function Pₘₙ(z₁,z₂,y) used in expression (11) may be the function defined above by expression (3).

Further, according to at least one example embodiment, it may be assumed that the source S is located in the street, and excitation may be treated in the standard manner of a point source in a waveguide. Thus, each modal coefficient is the mode function evaluated at the source location, and the source function used in both expressions 10 and 11, Sₘ(xₛ), may be defined as follows:

$${S}_{m} ( {x}_{s} ) = \sqrt{\frac{2}{a}} sin ( m π {x}_{s} / a ) , \qquad ( 12 )$$

Where m is a number of a mode of the source path segment associated with the point selected in step S210, where the source path segment is the path segment connected to the source S. Using the first point P1 as an example of the selected point, the first path segment 354 is the source path segment, and the second path segment 352 is not. Using the third point P3 as an example of the selected point, there are no corners in the path associated with the third point P3. Accordingly there is only one path segment in the path associated with the third point P3, and that path segment is the source segment. The value ‘a’ is a width of the first segment, and the value xₛ is a position along the x axis of the source segment at which the source S is located.

The method illustrated in FIG. 4 is explained with reference to an example in which steps S211-S213B are completed before steps S215-S217B. However, according to at least one example embodiment, steps S211-S213B may be completed after, or alternatively, in parallel with, steps S215-S217B.

Accordingly, in step S219, the radio field modeling device 101 determine an output of the utility function U(x,y,z) based on expression (10) or expression (11). The output may be expressed in units of, for example, a square root of power. For example, squaring the output of the utility function U(x,y,z) (e.g., (U(x,y,z))²) would produce a radio field power corresponding to the selected point for which the utility function U(x,y,z) was calculated.

Returning to FIG. 2, after step S219, the method proceeds to step S240 and an output of waveguide field equation U(x,y,z) constructed in step S230 is set as a predicted value of the radio field associated with the point selected in step S210. For example, the radio field modeling device 101 may set the output of the field equation U(x,y,z) constructed in step S230 as the predicted radio field value for the point selected in step S210 in a radio field model associated with the geographic area 300.

After step S240, in step S250 a new point is selected, and steps S210-S250 are repeated again for the new point. By performing steps S210-S240 for each point being modeled in the geographic area 300, the radio field modeling device 101 may generate a complete radio field model of the geographic area 300 using techniques which may be more accurate than simple distance based models like, for example, the Hata modeling method, and less costly in terms of computation resources than the ray tracing modeling method.

FIGS. 2-4 are described with reference to a single-path scenario where, for each point selected for radio field modeling in the geographic area 300, only a shortest street-based path is considered when determining a predicted radio field value for the selected point. A street-based path may be defined as, for example, a path traveling along one or more streets between the source S and the selected point. For example the paths associated with first through fourth points P1-P4 illustrated in FIG. 3 are all street-based paths.

However, according to at least one example embodiment, a multi-street scenario is implemented where multiple street-based paths are considered for one, plural or all points selected for radio field modeling. For example, for a selected point, in addition to the shortest street-based path, one or more other, longer street-based paths may exist and may be used to determine a predicted value of the radio field for the selected point. In this multiple-path scenario, for each selected point, the shortest n street-based paths between the source S and the selected point may be chosen, where n is a positive integer greater than 1.

Further, for each chosen street-based path, the field equation U(x,y,z) may be constructed and an output of the field equation U(x,y,z) may be determined in accordance with step S230 described above with reference to FIGS. 2-4. For example, steps S210-S240 may be executed for each of the n chosen street-based paths. Further, in the multiple-path scenario, in step 240, the outputs of the field equations U(x,y,z) corresponding, respectively, to each of the chosen street-based paths for the selected point are summed, and the resulting sum is used as the predicted value of the radio field for the selected point.

Further, in addition to using one or more street-based paths in order to determine the predicted value of the radio field for a selected point, an over-the-clutter-top path may be utilized. For example, in a geographic area that is urban or has several buildings, such as the geographic area 300, an over-the-clutter-top path may be defined as a path which is predominantly aerial and travels between the source S and the selected point above tops of buildings. According to at least one example embodiment, a radio field contribution of the over-the-clutter-top path may be determined in accordance with related art methods including, for example, the Hata modeling method or other distance based, slope intercept models. Further, according to at least one example embodiment, the radio field contribution of the over-the-clutter-top path may be summed with one or more outputs of the field equation U(x,y,z) determined in accordance with the single-path and multi-path scenarios discussed above, in order to generate the predicted value of the radio field for the selected point.

Additionally, in the example method described above with respect to FIGS. 2-4, paths having, at most, one corner and two path segments are shown. However, according to at least one example embodiment, outputs of the field equation U(x,y,z) may be determined for paths having more than one corner and more than two path segments. For example, those of ordinary skill in the art are able to calculate outputs of the field equation U(x,y,z) for paths having more than one corner and more than two segments by adapting expressions 3-7 and 11 to accommodate additional corners and path segments, in accordance with known methods.

According to at least one example embodiment, the radio field modeling device 101 may be programmed, in terms of software and/or hardware, to perform any or all of the functions described above with reference to FIGS. 2-4.

Examples of the radio field modeling device 101 being programmed, in terms of software, to perform any or all of the functions described above with reference to FIGS. 2-4 will now be discussed below. For example, the memory unit 160 may store a program including executable instructions corresponding to any or all of the operations described with reference to S210-S250 of FIGS. 2-4. According to at least one example embodiment, additionally or alternatively to being stored in the memory unit 160, the program may be stored in a computer-readable medium including, for example, an optical disc, and the radio field modeling device 101 may include hardware for reading data stored on the computer readable-medium. Further, the processor unit 150 may be configured to perform any or all of the operations described with reference steps S210-S250 of FIGS. 2-4, for example, by reading and executing the executable instructions stored in at least one of the memory unit 160 and a computer readable storage medium loaded into hardware included in the radio field modeling device 101 for reading computer-readable mediums.

Examples of the radio field modeling device 101 being programmed, in terms of hardware, to perform any or all of the functions described above with reference to FIGS. 2-4 will now be discussed below. Additionally or alternatively to executable instructions corresponding to the functions described above with reference to FIGS. 2-4 being stored in a memory unit or a computer-readable medium as is discussed above, the processor unit 150 may include a circuit that has a structural design dedicated to performing any or all of the operations described with reference to steps S210-S250 of FIGS. 2-4. For example, the circuit may be a field programmable gate array (FPGA) or an application specific integrated circuit (ASIC) physically programmed to perform any or all of the operations described with reference to steps S210-S250 of FIGS. 2-4.

Embodiments of the invention being thus described, it will be obvious that embodiments may be varied in many ways. Such variations are not to be regarded as a departure from the invention, and all such modifications are intended to be included within the scope of the invention.

What is claimed:

1. A method of modeling predicted values of radio fields originating from a source in a geographic area including a plurality of streets and a plurality of buildings, the method comprising:
selecting a point within the geographic area;
determining a first path from the source to the selected point, the first path including a first segment corresponding to a first street from among the plurality of streets, the first segment running along the first street; and
predicting a value, at the selected point, of a radio field originating from the source,
wherein predicting the value of the radio field at the selected point includes,
modeling the first segment as a first waveguide,
at least one of
generating a first radio field coupling equation by coupling the first waveguide with a second waveguide, the second waveguide being a model of a second segment, the second segment being included in the first path and running along a second street from among the plurality of streets, and
generating a second radio field coupling equation by coupling the first waveguide with an indoor model for modeling radio fields traveling through one or more of the plurality of buildings or an outer wall, and
predicting the value of the radio field at the selected point based on at least one of the first and second radio field coupling equations.

2. The method of claim 1, wherein the indoor model is a diffusion model.

3. The method of claim 1, wherein the modeling a first segment as a first waveguide includes generating the first waveguide such that the first waveguide has a width corresponding to a width of the first street.

4. The method of claim 1 wherein,
the first and second streets intersect at a corner,
the first and second segments meet at the corner, and
the predicting the value of the radio field at the selected point includes the generating a first coupling equation.

5. The method of claim 4 wherein,
the generating a first coupling equation includes generating the first coupling equation based on a corner angle, and
the corner angle is an angle of the corner at which the first and second segments meet.

6. The method of claim 5, wherein generating the first coupling equation includes modeling the corner as a waveguide junction between the first and second waveguides.

7. The method of claim 1 wherein,
the selected point is located inside a first building from among the plurality of buildings, and
the predicting the value of the radio field at the selected point includes the generating a second coupling equation.

8. The method of claim 7 wherein, the generating a second coupling equation includes generating the second coupling equation based on a diffusion constant, the diffusion constant corresponding to the first building.

9. The method of claim 1, further comprising:
determining a second path from the source to the selected point,
wherein the predicting the value of the radio field at the selected point includes,
determining a first radio field contribution based on the at least one of the first and second coupling equations,
determining a second radio field contribution based on the second path,
generating a summation value by performing a summation operation based on the first and second radio field contributions, and
predicting the value of the radio field at the selected point based on the summation value.

10. A radio field modeling device comprising:
a processor, the radio field monitoring device being programmed such that the processor executes operations for modeling predicted values of radio fields originating from a source in a geographic area including a plurality of streets and a plurality of buildings, the operations including,
selecting a point within the geographic area;
determining a first path from the source to the selected point, the first path including a first segment corresponding to a first street from among the plurality of streets, the first segment running along the first street; and
predicting a value, at the selected point, of a radio field originating from the source,
wherein predicting the value of the radio field at the selected point includes,
modeling the first segment as a first waveguide,
at least one of
generating a first radio field coupling equation by coupling the first waveguide with a second waveguide, the second waveguide being a model of a second segment, the second segment being included in the first path and running along a second street from among the plurality of streets, and
generating a second radio field coupling equation by coupling the first waveguide with an indoor model for modeling radio fields traveling through one or more of the plurality of building or outer wall, and
predicting the value of the radio field at the selected point based on at least one of the first and second coupling equations.

11. The radio field modeling device of claim 10, wherein the radio field modeling device is programmed such that the indoor model is a diffusion model.

12. The radio field modeling device of claim 10, wherein the radio field modeling device is programmed such that modeling a first segment as a first waveguide includes generating the first waveguide such that the first waveguide has a width corresponding to a width of the first street.

13. The radio field modeling device of claim 10 wherein the radio field modeling device is programmed such that,
the first and second streets intersect at a corner,
the first and second segments meet at the corner, and
the predicting the value of the radio field at the selected point includes the generating a first coupling equation.

14. The radio field modeling device of claim 13 wherein the radio field modeling device is programmed such that, the generating a first coupling equation includes generating the first coupling equation based on a corner angle, the corner angle being an angle of the corner at which the first and second segments meet.

15. The radio field modeling device of claim 14, wherein the radio field modeling device is programmed such that generating the first coupling equation includes modeling the corner as a waveguide junction between the first and second waveguides.

16. The radio field modeling device of claim 1 wherein the radio field modeling device is programmed such that the predicting the value of the radio field at the selected point includes the generating a second coupling equation, if the selected point is located inside a first building from among the plurality of buildings.

17. The radio field modeling device of claim 16 wherein the radio field modeling device is programmed such that, the generating a second coupling equation includes generating the second coupling equation based on a diffusion constant, the diffusion constant corresponding to the first building.

18. The radio field modeling device of claim 10, wherein the radio field modeling device is programmed such that the operations further include determining a second path from the source to the selected point,
wherein the predicting the value of the radio field at the selected point includes,
determining a first radio field contribution based on the at least one of the first and second coupling equations,
determining a second radio field contribution based on the second path,
generating a summation value by performing a summation operation based on the first and second radio field contributions, and
predicting the value of the radio field at the selected point based on the summation value.
